(19) United States
(12) Patent Application Publication
(10) Pub. No.: US 2006/0280042 A1
(43) Pub. Date: Dec. 14, 2006

(54) Apparatus for reproducing copyrighted data

(76) Inventor: Soo Sung Park, Seoul (KR)

Correspondence Address: HARNESS, DICKEY & PIERCE, P.L.C., P.O. BOX 828, BLOOMFIELD HILLS, MI, 48303, US

(21) Appl. No.: 11/438,018

(22) Filed: May 19, 2006

(30) Foreign Application Priority Data
Jun. 10, 2005 (KR) 10-2005-0049623

(51) Int. Cl. H04B 1/20

(52) U.S. Cl. 369/2

(57) ABSTRACT

Disclosed is an apparatus for reproducing copyrighted data, in more particular copyrighted sound source data and/or image data The apparatus includes: a data storage unit for storing copyrighted data; a controller for generating a control signal for reproducing the copyrighted data stored in the data storage unit; an output unit for outputting played signals for the copyrighted data according to the control signal from the controller; and a key input unit for inputting a signal for controlling the operation of the controller; a display unit for indicating the operating condition of the controller, the display unit displaying information concerning whether the copyrighted data is being played or not; a power source for applying driving power to the controller; and a case for receiving the data storage unit, the controller, the output unit, the key input unit, the display unit, and the power source. Therefore, as the copyrighted sound source and image data are integrally incorporated in the apparatus for reproducing the copyrighted data, the copyrighted sound source and image data can be played only by the data reproduction apparatus, thereby preventing unlawful reproduction of copyrighted data.

### BACKGROUND OF THE INVENTION

1. Field of the Invention

The present invention relates to a data reproduction apparatus, and more particularly to an apparatus for reproducing copyrighted sound source data and/or image data.

2. Description of the Prior Art

In general, conventional music recording mediums include long play (LP) records, audio cassette tapes, compact discs (CDs), etc., and apparatuses for reproducing a sound source contained in these mediums include LP players, cassette tape players, and compact disc (CD) players. Recently, MP3 players have appeared for reproducing an MP3 sound source.

A CD player may provide excellent audio quality as compared with an LP player or a cassette tape player. However, such a CD player is inconvenient in that when the CD player is used as portable purpose, careful attention should be paid in handling the CD player during the reproducing operation of the CD player because the CD player is very sensitive to external vibration and impact.

Apparatuses for reproducing image data as well as sound source data include video cassette recorders (VCR), digital versatile disc (DVD) players, or the like. Recently, the supply of VCRs and DVD players has been increased because they can provide high audio and video quality.

The recent abrupt development of Internet has accelerated digitalization of media as well as information searches, whereby audio cassette tapes and video tapes, which are of analogue type, and compact discs (CDs), which are of wave type, are on the way of being substituted by MPEG type mediums, which are superior in compression ratio and transmission speed. In particular, the spread and use of MP3s, which can most efficiently compress a sound source such as audio data among the MPEG type mediums, have dramatically increased, because they can not only store ordinary audio data but also transmit high quality music in a high speed using various communication means.

Such MP3s can compress existing wave files to one-eleventh their original size with a sound compression standard so-called “MPEG Audio Layer-3,” while retaining excellent sound quality. As a result, music-only web sites as well as information providing web sites widely execute distribution of sound sources using MP3s so as to increase the access times of users.

In addition, the spread of MP3 share programs, such as Napster (www.napster.com) and Soribada (www.soribada.com), disturbs the disc market, thereby causing a serious problem of an infringement of copyright; there is a problem in that the MP3 share programs are difficult to assure a good sound source because they employ user to user MP3 file sharing as well as they act as a factor of hindering sound source providers from a chance of creating interest.

Furthermore, sound source providers, who provide sound sources using MP3 on Internet, are in a position where it is practically difficult or impossible for them to offer a sound source service, which is not directly related to the provision of required information, while bearing a burden of costs for copyright, as well as to provide sound sources boundlessly without solving the issue of copyright. Furthermore, as digital right management (DRM) or the like has been recently applied, it becomes further difficult to use sound sources without cost.

In addition, because it is easy to unlawfully converts sound source stored in CD, DVD or the like into an MP3 or MP4 file or the like, there are problems in that unlawful use of copyrighted works is on an increasing trend and in that the right of a copyright holder cannot be properly protected due to unlawful reproductions.

### SUMMARY OF THE INVENTION

Accordingly, the present invention has been made to solve the above-mentioned problems occurring in the prior art, and an object of the present invention is to provide an apparatus for reproducing data, in which copyrighted data is stored and which is adapted to play only the copyrighted data.

In order to achieve the above-mentioned object, there is provided an apparatus for reproducing copyrighted data including: a data storage unit for storing copyrighted data; a controller for generating a control signal for reproducing the copyrighted data stored in the data storage unit; an output unit for outputting played signals for the copyrighted data according to the control signal from the controller; and a key input unit for inputting a signal for controlling the operation of the controller; a display unit for indicating the operating condition of the controller, the display unit displaying information concerning whether the copyrighted data is being played or not; a power source for applying driving power to the controller; and a case for receiving the data storage unit, the controller, the output unit, the key input unit, the display unit, and the power source.

The data reproduction apparatus may further include a ring connection part formed at a side of the case, wherein the ring connection part has a through-hole, which is formed through the ring connection part for inserting a connection ring into the through-hole.

In addition, the data storage unit is a memory device, which is adapted to prevent the overwrite of data on the copyrighted data and allow only the played signal for the copyrighted data to be outputted. The memory may be at least one selected from a NAND-type flash memory, a NOR-type flash memory, a mask ROM, a magnetic memory, a phase memory, and a ferroelectric memory.

The copyrighted data may include at least one of sound source data and image data.

The output unit may include at least one of an earphone plug-in port and a TV connector plug-in port.

The case may be formed in a circular or polygonal shape when viewed from the front thereof and include an information indication area on a side thereof so as to indicate information concerning the copyrighted data.

The information indication area may be formed in a circular or polygonal shape through embossing or intaglioing.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the configuration of the inventive apparatus for reproducing copyrighted data;

FIG. 2 is a perspective view illustrating an embodiment of the inventive apparatus for reproducing copyrighted data; and

FIG. 3 is a perspective view illustrating another embodiment of the inventive apparatus for reproducing copyrighted data according to another embodiment of the present invention.

### DETAILED DESCRIPTION OF THE PREFERRED EMBODIMENTS

Hereinafter, preferred embodiments of the present invention will be described with reference to the accompanying drawings.

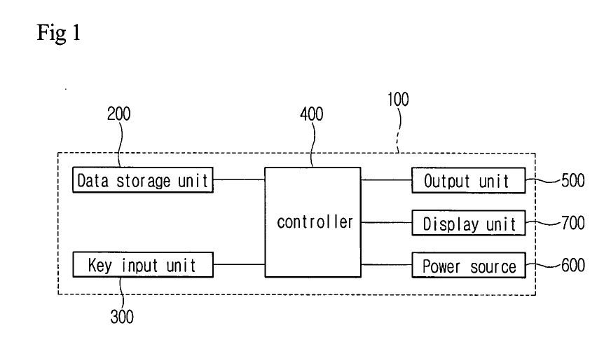

FIG. 1 is a block diagram illustrating the configuration of the inventive apparatus for reproducing copyrighted data. Referring to FIG. 1, the inventive apparatus for reproducing data 100 (hereinafter, to be referred to as “data reproduction apparatus”) includes a data storage unit 200 for storing copyrighted data, a key input unit 300 for inputting signals for operating the data reproduction apparatus 100, a controller 400 for reproducing the copyrighted data stored in the data storage unit 200, an output unit 500 for outputting signals produced as the data stored in the data storage unit 200 is being played, a power source 600 for supplying power for driving the data reproduction apparatus 100, and a displaying unit 700 for indicating the operation of the data reproduction apparatus 100.

The term “copyrighted data” means data, for which an exclusive right given to an author of a creative work is recognized, wherein the copyrighted data according to the present invention includes sound source data, of which the sound is recognized as a creative work, and image data, such as a still picture, a moving picture or the like. The sound source data may include voice, music, etc., and the image data may contain simply a pure picture such as a still photograph, or include both sound and pictures like a movie, a TV drama or the like.

The data storage unit 200 is configured to store copyrighted data. Preferably, the data storage unit 200 is a memory, which is adapted to prevent data from being overwritten on the copyrighted data stored in the memory, and to allow only the signals for use in reproducing the copyrighted data to be outputted from the memory. Namely, after being stored with the copyrighted data, the data storage unit 200 is adapted to prevent any data from being written (stored) in the data storage unit 200 from the outside and to allow only the signals for use in reproducing the copyrighted data stored in the data storage unit 200 to be outputted. The memory includes at least one selected from a NAND-type flash memory, a NOR-type flash memory, a Mask-ROM, a magnetic memory, a phase memory, and a ferroelectric memory.

In addition, the data stored in the data storage unit 200 is stored in a file format, wherein sound source data such as voice is preferably stored in an MP3 format file and image data is stored in an MP4 format file.

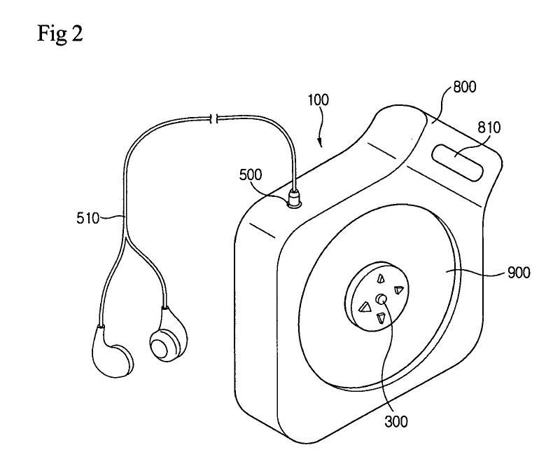

The key input unit 300 is provided for inputting a control signal for driving the data reproduction apparatus 100 for reproducing copyrighted data. The key input unit 300 is now described with reference to FIG. 2, which illustrates an embodiment of the inventive data reproduction apparatus for reproducing copyrighted data.

Referring to FIG. 2, the key input unit 300 is provided on a side of the data reproduction apparatus 100, so that the data reproduction apparatus 100 can play sound source data or image data stored in the data storage unit 200 as the key input unit 300 is manipulated. Namely, it is possible to input a control signal for driving the data reproduction apparatus 100 by moving the key input unit 300 up, down, right or left, or pushing the key input unit 300. Although the key input unit 300 is installed at the center of a side of the data reproduction apparatus 100 in the present invention, it would be apparent to one skilled in the art that the installation position of the key input unit 300 could be readily changed.

Referring to FIG. 1 again, the controller 400 functions to generate control signals for reproducing the copyrighted data stored in the data storage unit 200; the controller 400 only executes the function of reproducing the copyrighted data stored in the data storage unit 200 and does not executing the writing (storage) of data into the data storage unit 200 from the outside. That is, the controller 400 prevents data, which is inputted from the outside, from being written (stored) into the data storage unit 200 or overwritten on the copyrighted data, detects data, which is requested to be played among the copyrighted data, so that sound source data and/or image data are played, and outputs the sound source and/or image signals as being played, thereby preventing the copyrighted original data itself from being unlawfully reproduced.

In addition, when the copyrighted data stored in the data storage unit 200 is played, the controller 400 generates a control signal for indicating the operation of the data reproduction apparatus 100, so that a user could confirm whether the data reproduction apparatus 100 is operated or not.

The output unit 500 serves to connect the signals played by the controller 400 with an external output device (not shown), so that the played signals can be outputted through the external output device. Referring to FIGS. 1 and 2, in a case in which the data stored in the data storage unit 200 is sound source data, the output unit 500 interconnects the controller 400 and an earphone 510, so that the sound source data being played could be outputted through the earphone 510. Preferably, the output unit 500 is an earphone plug-in port. That is, the output unit 500 outputs only the signals played by the data reproduction apparatus 100.

The power source 600 is connected with the controller 400 so as to supply power to the individual components of the data reproduction apparatus 100 through the controller 400. The power source 600 consists of at least one of a primary battery and a secondary battery; preferably the power source 600 consists of a primary battery.

The display unit 700 serves to indicate whether the data reproduction apparatus 100 is operated or not by the controller 400 and consists of at least one of an LED and an LCD; preferably, the display unit 700 consists of an LED. That is, when the copyrighted data stored in the data storage unit is played according to a control signal from the controller 400, the display unit 700 causes the LED to illuminate according to the control signal outputted from the controller 400, thereby indicating whether the data is being played or not.

Meanwhile, when shown in a front view, the inventive data reproduction apparatus 100 has an outer appearance which takes a circular or polygonal shape, preferably a quadrilateral shape.

A ring connection part 800 is formed at a corner of the data reproduction apparatus 100, and a through-hole 810 is preferably formed through the center of the ring connection part 800 for inserting a connection ring or string for holding the data reproduction apparatus 100.

In addition, an information indication area 900 is provided on a side of the data reproduction apparatus 100 for indicating brief information, which allows a user to confirm the content of the copyrighted data stored in the data reproduction apparatus 100.

Preferably, the brief information may include one or more photographs, the names of data stored in the data storage unit 200, or the like, which are printed on the front side of a printed material, for example, for advertisement, wherein the printed material is adhered to the information indication area 900 by an adhesive coating on the rear side of the printed material.

In addition, the information indication area 900 may be formed through embossing or intaglioing in a circular or polygonal shape on the corresponding side of the data reproduction apparatus 100. As the information indication area 900 takes an embossed or intaglioed circular or polygonal shape, the design of the data reproduction apparatus 100 could be improved.

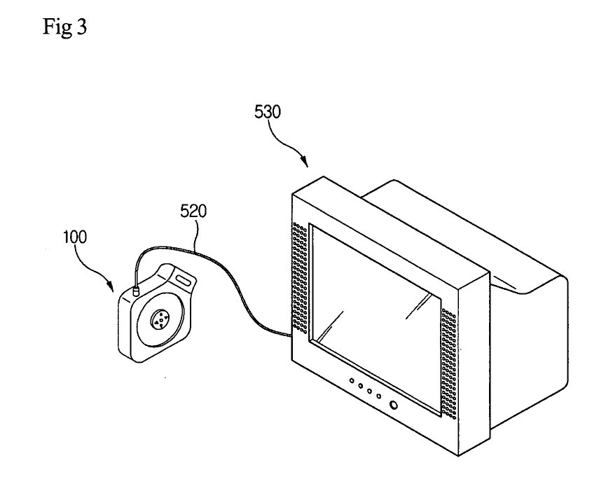

FIG. 3 is a perspective view showing another embodiment of the inventive data reproduction apparatus for reproducing copyrighted data, wherein the data reproduction apparatus 100 of FIG. 3 is differentiated from the data reproduction apparatus 100 of FIG. 2 as follows: the data reproduction apparatus 100 of FIG. 2 has an output unit 500 which is formed as an earphone plug-in port, so that the copyrighted data stored in the data reproduction apparatus 100 is outputted through an earphone 510 (see FIG. 2), while the data reproduction apparatus 100 of FIG. 3 has an output unit 500 which is formed as a TV connector plug-in port, so that in a case in which the copyrighted data stored in the data reproduction apparatus 100 is image data, the image data played through a controller 400 (see FIG. 1) is transmitted to a TV 530 through a connection cable 520.

That is, the above-mentioned arrangement is made in such a way that one end of the connection cable 520 is connected to the output unit 500 of the data reproduction apparatus 100 and the other end is connected to an external terminal connection unit (not shown) formed on a side of the TV 530, and that the output unit 500 (see FIG. 1) could output audio and video signals, wherein it is more preferable that the output unit 500 could separately output the video signals of red (R), green (G) and blue (B), and the audio signals.

Accordingly, the copyrighted data stored in the data storage unit 200 is allowed to be played only by the data reproduction apparatus 100 which is integrally formed with the copyrighted data, thereby preventing the unlawful reproduction of the copyrighted data.

As described above, the present invention has an advantage in that because copyrighted sound source and image data are stored in a data storage unit so that they can be played only by a data reproduction apparatus integrally formed with the copyrighted data, it is possible to prevent the unlawful reproduction of the copyrighted sound source and image data.

In addition, the present invention has an advantage in that because only the sound signals and/or video signals, which are produced by reproducing copyrighted data, are allowed to be outputted, it is possible to prevent copyrighted original data itself from being unlawfully reproduced.

Furthermore, by preventing the unlawful reproduction of original data, there is also an advantage in that it is possible to prevent the occurrence of unlawful reproductions of high quality audio and video data and to block the circulation of such reproductions.

It is also expected that the inventive data reproduction apparatus could replace expensive MP3 apparatuses.

Moreover, the inventive data reproduction apparatus could be used as an electronic album which can solve the problem of a conventional CD music album that the new music contained in the album could be reproduced so easily.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An apparatus for reproducing copyrighted data comprising:
a data storage unit for storing copyrighted data;
a controller for generating a control signal for reproducing the copyrighted data stored in the data storage unit;
an output unit for outputting played signals for the copyrighted data according to the control signal from the controller; and
a key input unit for inputting a signal for controlling the operation of the controller;
a display unit for indicating the operating condition of the controller, the display unit displaying information concerning whether the copyrighted data is being played or not;
a power source for applying driving power to the controller; and
a case for receiving the data storage unit, the controller, the output unit, the key input unit, the display unit, and the power source.

2. An apparatus as claimed in claim 1, further comprising a ring connection part formed at a side of the case, wherein the ring connection part has a through-hole which is formed through the ring connection part for inserting a connection ring into the through-hole.

3. An apparatus as claimed in claim 1 or 2, wherein the data storage unit is a memory, which is adapted to prevent overwrite data on the copyrighted data and allow only the played signal for the copyrighted data to be outputted.

4. An apparatus as claimed in claim 3, wherein the memory is at least one selected from a NAND-type flash memory, a NOR-type flash memory, a mask ROM, a magnetic memory, a phase memory, and a ferroelectric memory.

5. An apparatus as claimed in claim 1 or 2, wherein the copyrighted data comprises at least one of sound source data and image data.

6. An apparatus as claimed in claim 1 or 2, wherein the output unit comprises at least one of an earphone plug-in port and a TV connector plug-in port.

7. An apparatus as claimed in claim 1 or 2, wherein the case comprises an information indication area on a side thereof so as to indicate information concerning the copyrighted data.

8. An apparatus as claimed in claim 7, wherein the information indication area is formed in a circular or polygonal shape.

9. An apparatus as claimed in claim 7, wherein the information indication area is formed through embossing or intaglioing.

10. An apparatus as claimed in claim 1 or 2, wherein the case has an external appearance which takes a circular or polygonal shape.
